(19) United States
(12) Patent Application Publication
(10) Pub. No.: US 2025/0297858 A1
(43) Pub. Date: Sep. 25, 2025

(54) Gyroscopic measurement method and sensor

(71) Applicant: THALES, Meudon (FR)

(72) Inventors: Nicolas Jean-Marc Frédéric VERCIER, VALENCE CEDEX (FR); Nicolas Paul MARTIN, VALENCE CEDEX (FR)

(21) Appl. No.: 18/788,315

(22) Filed: Jul. 30, 2024

(30) Foreign Application Priority Data
Mar. 25, 2024 (FR) 2402970

(51) Int. Cl. G01C 19/5776; G01C 25/00

(52) U.S. Cl. CPC G01C 19/5776; G01C 25/005

(57) ABSTRACT

The present invention relates to a sensor (10) comprising a housing (12) and a vibrating element (15) apt to vibrate relative to the housing (12), comprising:
an initialization (410), to provide a pilot amplitude (xₘₐₓ), a detection amplitude (yₘₐₓ), an adjustment command (T^{th}) of predetermined spectral signature, and a calibration angular speed (Ω_{cal});
a calibration (420), comprising the servoing to the pilot amplitude and to the detection amplitude of the vibrations of the vibrating element (15) along the direction (x) of the pilot mode and the direction (y) of the detection mode, and simultaneously the exertion of a first stable force (F_{y,phase,supp}^{app}) configured not to disturb the measurement of the sensor (10) from the adjustment command (T^{th}), as well as the application of a second force (F_{y,quad}^{app}) determined on the basis of the spectral signature of the adjustment command so as to cause a rotation of the direction of the pilot mode, an instantaneous angular speed (Ω(t)) of the housing (12) being imposed as equal to the calibration angular speed (Ω_{cal}), and the determination of a reference angular speed (Ω_{ref});
an acquisition (430), analogous to the calibration but with a free instantaneous angular speed (Ω(t)); a determination (440) of a measured instantaneous angular speed (Ωₘₑₛ(t)).

### BACKGROUND OF THE DISCLOSURE

### Field of the Disclosure

The present invention relates to a gyroscopic measurement method.

The invention further relates to a gyroscopic sensor for implementing the gyroscopic measurement method, as well as to a computer program comprising instructions which lead the sensor to execute the step of determining the instantaneous angular speed of the gyroscopic sensor of the method.

### Description of Related Art

A Coriolis Vibratory Gyroscope (CVG) sensor makes it possible to measure the component along an axis, called the axis of sensitivity, of an instantaneous speed of rotation vector of a frame of reference attached to a sensor housing with respect to an inertial frame of reference.

For this purpose, the CVG comprises a vibrating sensor element, apt to vibrate with respect to the housing. The measurement can be made due to the effects of the Coriolis inertial force exerted on the vibrating element.

The vibrating element of a CVG is apt to vibrate in two coplanar vibration directions, called pilot mode direction and detection mode direction, the work of the Coriolis force making possible a transfer of mechanical energy between the two directions.

The axis of sensitivity of the CVG is orthogonal to the plane of the directions of the pilot mode and of the detection mode.

For the measurements, the vibrating element is excited, by the excitation system, along the direction of the pilot mode at the resonant frequency. The amplitude of the vibrations according to the pilot mode is kept constant by means of a servo system by means of which the voltage applied to the excitation system is controlled. Any variations in the resonant frequency, in particular related to variations in the temperature of the vibrating element, are monitored by means of a frequency control system.

If the component along the axis of sensitivity of the instantaneous speed of rotation vector of the housing with respect to an inertial frame of reference is non-zero, the displacement of the vibrating element along the direction of the pilot mode generates a Coriolis force. Said force excites the vibrating element along the direction of the detection mode, at an amplitude which is proportional to the component along the axis of sensitivity of the instantaneous speed of rotation vector.

A CVG can operate in two modes: gyroscope mode and gyrometer mode.

In the gyroscope mode, the position of the pilot mode direction in the vibratory plane is free. The instantaneous speed of rotation to be measured is then deduced from the angular position of the vibration plane of the vibrating element in the frame of reference attached to the housing.

In the gyrometer mode, the direction of the pilot mode in the vibration plane is servoed by sending an electronic command and the instantaneous speed of rotation to be measured is deduced from the force to be exerted to servo the direction.

Whether the CVG is used in the gyroscopic mode or in the gyrometer mode, the measurements are subject to intrinsic errors related to the defects of the CVG. The defects include the stiffness or damping anisotropies of the vibrating element, the defects of the electronic control components of the excitation or of the electronic detection components of the position of the vibrating element, the defects of the electrical reference voltage for the excitation, etc.

Among the errors, some are called harmonic errors because they are proportional to cosine or sine functions of an even multiple angle of the angle characterizing the direction of the pilot mode in the frame of reference attached to the housing.

U.S. Pat. No. 6,598,455 describes a gyroscopic measurement method wherein the geometrical vibration position of the gyroscope is modified voluntarily by electrostatic means over time, in order to improve the calibration of the gyroscope.

U.S. Pat. No. 7,093,370 describes, moreover, a MEMS gyrometer wherein an angular speed is deliberately imposed on the sensor by mechanical means. the direction of rotation of the sensor being periodically alternated in order to reduce measurement errors and in particular errors of scale factors of the gyrometer.

FR 2937414 describes a vibrating gyroscope that combines the principles of U.S. Pat. No. 6,598,455, by injecting an electronic signal to rotate the vibration wave, and of U.S. Pat. No. 7,093,370, by imposing a periodically alternating electrical rotation for minimizing harmonic errors. The command signal is suitable for rotating the geometrical vibration position of the gyroscope in a first direction during a part of the period of the command signal according to a first speed profile and then in an opposite direction according to a second speed profile. The vibrating gyroscope then provides a corrected signal which is based on the difference between the measurement signal and the command signal.

However, due to errors in the conversion chain of the command signal into electrostatic force, the force actually applied to the vibrating element of the gyroscope for obtaining the alternating rotation thereof is different from the force that should theoretically be obtained from the command signal.

If the errors of the conversion chain are perfectly stable over time, the error made on the angle measurement can be zero over a period characteristic of the variations of the command signal.

However, this is very unlikely, as the sources of error are numerous and of different kinds. The errors include detection errors of the detection combs, excitation errors of the excitation combs and instabilities of the reference voltage used for the operation of the combs, and errors in the electronic boards that coordinate the implementation of the gyroscopic measurement method.

Ultimately, in most situations, the mean value of the error committed is not zero over a period of the alternating rotation of the sensor position. Moreover, during the round trip of the wave, the angular errors of the sensor are all the greater the more significant the above-mentioned defects.

Such a device reduces the impact of defects on the measurement without, however, making it possible to evaluate the measurement error related to these defects.

Furthermore, the command signal used in FR 2937414 should be used to return to the same angular position between the beginning and the end of the control period. In cases where the gyroscope is moving in the inertial frame of reference and not at rest in this frame of reference, such a signal cannot serve to obtain both a zero mean command signal and to return to the same angular position.

### BRIEF SUMMARY OF THE DISCLOSURE

An aim of the invention is then to propose a gyroscopic measurement method wherein an alternating rotation of the directions of the pilot and detection modes of the gyroscopic sensor is controlled, and wherein the measurement errors, in particular the scale factor error, are reduced.

To this end, the subject matter of the invention is a gyroscopic measurement method by means of a sensor comprising a housing and a vibrating element apt to vibrate relative to the housing in a vibration plane simultaneously along a direction of a pilot mode and along a direction of a detection mode different from the direction of the pilot mode, the method comprising the following steps:
initialization, during which a pilot amplitude, a detection amplitude, an adjustment command with a predetermined spectral signature, and a calibration angular speed are provided;
calibration, comprising:
i) servoing to the pilot amplitude a first amplitude of forced sinusoidal vibrations of the vibrating element along the direction of the pilot mode,
ii) simultaneously, exerting of a first stable force on the vibrating element configured so as not to disturb the sensor measurement from the adjustment command, and servoing to the detection amplitude a second amplitude of vibrations of the vibrating element along the direction of the detection mode;
iii) simultaneously, exerting a second force on the vibrating element, along the direction of the detection mode and in phase quadrature with the first force, the second force being determined on the basis of a third force which estimates the actual force exerted to servo the second amplitude and of the spectral signature of the adjustment command and configured to cause a rotation of the pilot mode direction relative to the housing,
an instantaneous angular speed of the housing with respect to a sensitive axis being imposed and equal to the calibration angular speed during i), ii) and iii);
iv) determining a reference angular speed from the calibration angular speed and from measurements of the vibrations of the vibrating element during iii);
   an acquisition step which comprises i), ii) iii) of the calibration with a free instantaneous angular speed;
   determination of a measured instantaneous angular speed of the housing with respect to the sensitive axis from measurements of the vibrations of the vibrating element during the acquisition and from the reference angular speed.

In the method according to the invention, an adjustment command is used to apply on the vibrating element a first force along the direction of the detection mode, in phase with the vibrations according to the pilot mode.

The servoing of the amplitude of the vibrations according to the detection mode is done in the presence of the first force and allows the second determination module to implicitly estimate the first force.

The first force is stable and configured so as not to disturb the measurement made by the sensor.

A second force is then exerted from this estimate of the first force, in phase quadrature with the first force, along the direction of the detection mode of the sensor.

Such way of obtaining the second force leads to a good stability of the second force.

The second force is, as in the prior art, commanded to cause an additional rotation of the directions of the pilot mode and of the detection mode, in addition to the rotation related to the Coriolis force in order to reduce the harmonic errors of the sensor.

The calibration step allows determining a reference angular speed from which the measured angular speed will subsequently be determined, without an explicit value of the second force being used at any time, due to the particular and stable way of obtaining the second force.

Unlike patent FR 2937414, the measurement is deduced from the measurement signal not by suppressing an injected signal that is supposed to reconstruct a precession force but by suppressing a precession command that results from the projection of a force obtained through the servo commands, the force being used to counter the injection of a very stable force intentionally injected on the sensor. In other words, to obtain the angular speed at the output, one does not subtract from the measurement, an unstable controlled signal but the image of force which is a very stable by design.

Measurement errors, in particular the error related to the scale factor, are thus reduced.

According to an advantageous aspect of the invention, the calibration comprises:
i) servoing to the pilot amplitude a first amplitude of the forced sinusoidal vibrations of the vibrating element along the direction of the pilot mode,
ii) simultaneously, exerting a first force on the vibrating element, along the direction of the detection mode and in phase with the vibrations of the vibrating element along the direction of the pilot mode, from the adjustment command, and servoing to the detection amplitude a second amplitude of the vibrations of the vibrating element in the direction of the detection mode,
iii) simultaneously, exerting a second force on the vibrating element, along the direction of the detection mode and in phase quadrature with the first force, the second force being determined on the basis of a third force which estimates the actual force exerted to servo the second amplitude and of the spectral signature of the adjustment command and configured to cause a rotation of the pilot mode direction relative to the housing,
an instantaneous angular speed of the housing with respect to a sensitive axis being imposed and equal to the calibration angular speed during i), ii) and iii),
and the acquisition comprises i), ii) iii) of the calibration with a free instantaneous angular speed.

According to other advantageous aspects of the invention, the gyroscopic measurement method comprises one or a plurality of the following features, taken individually or according to all technically possible combinations:
for the calibration, the first force is exerted on the vibrating element, along the direction of the detection mode and in phase with the vibrations of the vibrating element along the direction of the pilot mode;
the calibration angular speed is zero;
the detection amplitude is zero;
the determination of the second force during calibration and during acquisition comprises filtering the third force which estimates the force actually exerted to servo the second amplitude;
the first force is exerted by means of an electrostatic device configured to exert a force directly proportional to a position of the vibrating element according to the direction of the pilot mode and according to the adjustment command;
the adjustment command is of the form:

$${T}^{th} = {T}_{0} + {T}_{1} cos ( θ ) + {T}_{2} cos ( 2 θ ) + … + {T}_{n} cos ( n θ )$$

where n is a strictly positive integer, Tᵢ—for i being an integer between 1 and n—is a constant term and θ is an angular position of the direction of the pilot mode with respect to a reference axis of a frame of reference attached to the housing, the reference axis being orthogonal to the sensitive axis;
a first adjustment command is provided during a first time interval and a second adjustment command, which is the opposite of the first adjustment command, is provided during a second time interval, such that the direction of the pilot mode relative to the housing rotates in a first direction during the first time interval and in a direction opposite to the first direction during the second time interval.

The invention further relates to a gyroscopic sensor comprising:
a housing;
a vibrating element apt to vibrate relative to the housing in a vibration plane simultaneously along a direction of a pilot mode and along a direction of a detection mode different from the direction of the pilot mode;
a first servo module, configured to receive a pilot amplitude and servo a first amplitude of forced sinusoidal vibrations of the vibrating element in the direction of the pilot mode to a predetermined pilot amplitude;
a second servo module configured to:
a) exert on the vibrating element a first stable force configured so as not to disturb the sensor measurement from an adjustment command with a predetermined spectral signature,
b) servo a second vibration amplitude of the vibrating element along the direction of the detection mode to a predetermined detection amplitude, and
c) exert a second force on the vibrating element along the direction of the detection mode and in phase quadrature with the first force, the second force being configured to cause rotation of the direction of the pilot mode relative to the housing, the second force being determined on the basis of a third force which is an estimate of the actual force exerted to servo the second amplitude and the spectral signature of the adjustment command;
   a measurement module configured to generate measurements of the vibrations of the vibrating element along the direction of the pilot mode and the direction of the detection mode and to exchange data with the first servo module and with the second servo module;
   a determination module configured to exchange data with the measurement module and with the first and second servo modules and configured to determine:
i) a reference angular speed from a predetermined calibration angular speed and from measurements of the vibrations of the vibrating element transmitted by the measurement module in a calibration mode for which an instantaneous angular speed of the housing with respect to a sensitive axis is imposed and equal to the calibration angular speed, and
ii) a measured instantaneous angular speed of the housing relative to the sensitive axis from measurements of the vibrating element in an acquisition mode for which the instantaneous angular speed is free and from the reference angular speed.

According to another advantageous aspect of the invention, the first servo module and the second servo module comprise means of electrostatic excitation.

The invention also relates to a computer program comprising instructions which cause the sensor according to one of the preceding embodiments to execute the method according to any one of the embodiments described hereinabove.

### BRIEF DESCRIPTION OF THE SEVERAL VIEWS OF THE DRAWING(S)

The invention will be clearer upon reading the following description, given only as an example, but not limited to, and making reference to the drawings wherein:

FIG. 1 is a schematic representation of a CVG according to the invention;

FIG. 2 is a schematic representation of the operation of a CVG of the prior art.

FIG. 3 is a schematic representation of the CVG system shown in FIG. 1;

FIG. 4 is a schematic representation of the trajectory of the vibrating element of FIG. 1 and of the directions of the pilot and detection modes thereof in a space coordinate frame attached to the housing;

FIG. 5 is a flowchart representation of an embodiment of a method according to the invention;

FIG. 6 is a partial representation of a set-up according to an excitation electrostatic device.

FIG. 7 is a flowchart representation of a method of the prior art used in the CVG of FIG. 2;

FIG. 8 is a detailed flowchart representation of the acquisition step 430 of the method shown in FIG. 5.

### DETAILED DESCRIPTION OF THE DISCLOSURE

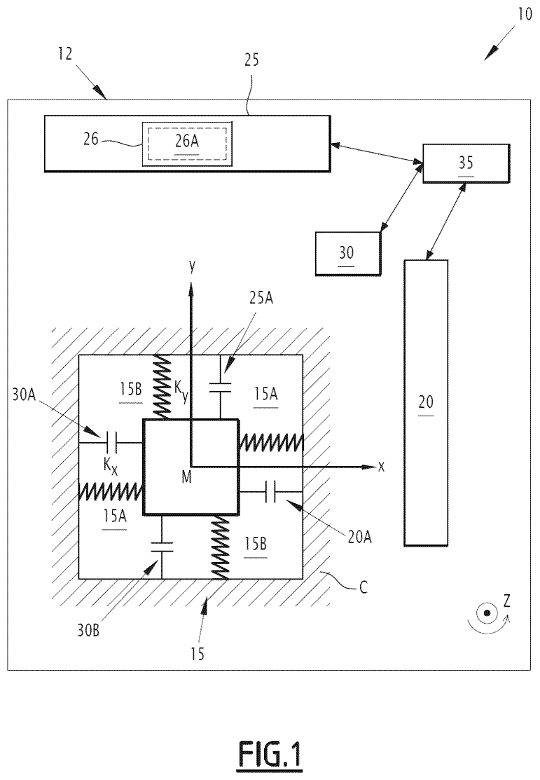

The Coriolis effect gyroscopic sensor 10, referred to by the abbreviation CVG hereinafter, according to the invention is described with reference to FIG. 1.

The CVG 10 includes a housing 12 and a vibrating element 15 apt to vibrate with respect to the housing 12.

The CVG 10 is for example produced in the form of a micro electromechanical sensor (MEMS) system. The vibrating element 15 and the housing 12 are then cut from a silicon or quartz block by micromachining and the vibrating element 15 is vibrated using an electrical method. Such arrangement makes it possible to minimize the overall size and/or the manufacturing cost of the CVG 10.

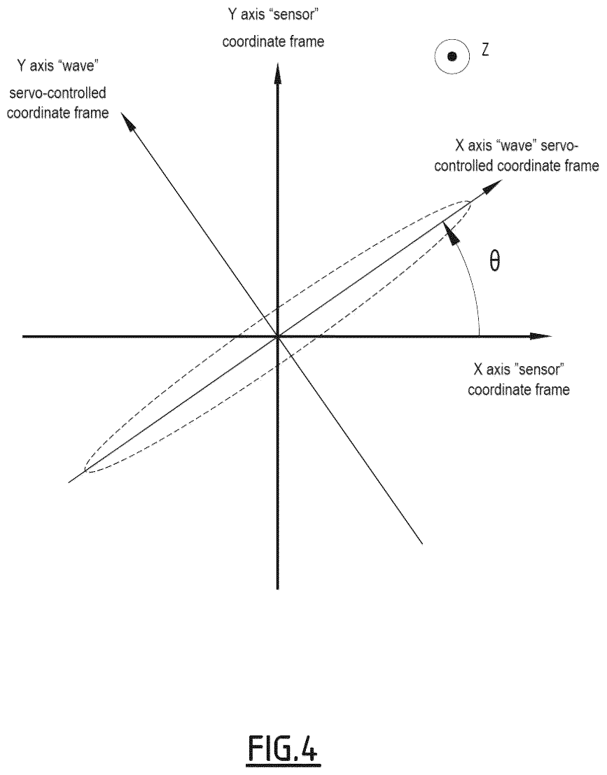

Three axes X, Y, Z of the space coordinate frame XYZ of a frame of reference (XYZ, t) attached to the housing 12 are shown in FIG. 4, the axis Z being of fixed direction in a space coordinate frame of an inertial frame of reference.

The CVG 10 is configured to measure an instantaneous angular speed Ω(t) of the sensor relative to the axis Z, which is thus the axis of sensitivity (or, equivalently, the sensitive axis) of the CVG 10.

To this end, the vibrating element 15 comprises a test mass M, apt to vibrate in plane XY along two directions x and y, with a natural angular frequency ω₀ₓ, respectively ω_{0y} close to ω₀ₓ.

Hereinafter, it is considered that the direction x is the direction of the pilot mode and that the direction y is the direction of the detection mode.

As can be seen in FIG. 4, the angular position of the direction x of the pilot mode is identified by the angle θ defined with respect to the reference axis X of the space coordinate frame XYZ attached to the housing 12.

The test mass M is apt to vibrate along the direction x of the pilot mode and the direction y of the detection mode, with a resonance angular frequency ω close to ω₀ₓ.

The CVG 10 includes a first servo module 20 apt to servo a characteristic amplitude of vibrations of the vibrating element 15 to a predetermined non-zero pilot amplitude xₘₐₓ, the vibrating element 15 vibrating in a sinusoidal regime forced to the resonance angular frequency ω along the direction x of the pilot mode, from measurement data of the position of the vibrating element in the direction x of the pilot mode.

The first servo module 20 comprises usual means for servoing (or equivalently controlling) the amplitude of the vibrations of the vibrating element 15 according to the pilot mode. Said means are not shown in detail in the figures. Same are e.g. the control means described in document EP2960625.

As an example, which will be referred to hereinafter as “reference example”, the first servo module 20 comprises an electrostatic device 20A configured to exert a first force F_{x,ass}, along the direction x of the pilot mode, on the vibrating element 15. The first force F_{x,ass} is then proportional to a first amplitude command.

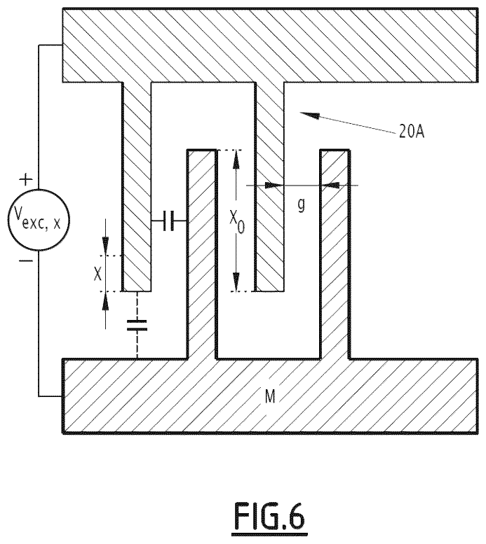

The electrostatic device 20A and the test mass M of the vibrating element 15 form, as an example, a set of interdigitated combs, as shown in FIG. 6. The first amplitude command is a voltage V_{exc,x}(t) imposed on the electrostatic device 20A by the servo module 20.

In the case of FIG. 6, the force applied to the test mass M along the direction x of the pilot mode at time t has the form F_{x,ass} (t)=f_{geom}V_{ex,x}²(t) where:
f_{geom} is a factor depending on the geometry of the combs, and
V_{exc,x} is the voltage imposed by the generator.

In general, the voltage V_{exc,x} has the form V_{exc,x} (t)=V₀ₓ+V₁ₓ cos (ωt). Thereby, the force actually applied to the test mass M is, after filtering the 2ω angular frequencies terms, has the form:

$${F}_{x , ass} ( t ) = {f}_{geom} ( {V}_{0 x}^{2} + \frac{1}{2} {V}_{1 x}^{2} + 2 {V}_{0 x} {V}_{1 x} cos ( ω t ) ) \qquad [ Math 1 ]$$

The constant term of the force is not used hereinafter, since only the last term allows the test mass M to oscillate. In other words, the non-sinusoidal terms are either filtered naturally or filterable by an appropriate filtering stage.

Finally, it should be understood that the electrostatic device 20A can be configured by a person skilled in the art to exert a first force F_{x,ass} of angular frequency substantially equal to the natural angular frequency ω₀ₓ of the vibrating element 15 according to the pilot mode, from a suitably chosen amplitude command, to obtain the servoing of the amplitude of the vibrations of the vibrating element 15 to the pilot amplitude xₘₐₓ.

The first servo module 20 comprises in the reference example a processor or a programmable logic circuit (such as a Field Programmable Gate Array, FPGA), configured to manage the servoing of the first amplitude command, as well as a proximity board configured to inject the first amplitude command signal into the electrostatic device 20A.

The processor or the programmable logic circuit is advantageously configured to manage the servoing of the angular frequency of the vibrations of the vibrating element 15 along the direction x of the pilot mode, e.g. to the resonance angular frequency ω.

The CVG 10 includes second servo module 25 apt to control (or equivalently servo) a characteristic amplitude of vibrations of the vibrating element 15 along the direction Y of the detection mode to a detection amplitude yₘₐₓ, the vibrating element 15 vibrating in a forced sinusoidal regime along the direction y of the detection mode at the resonance angular frequency ω, from measurement data of the position of the vibrating element along the direction y of the detection mode.

To this end, the second servo module 25 may comprise control means similar to the means of the first servo module 20 (not shown in detail).

Thereby, in the reference example, the second servo module 25 comprises an electrostatic device 25A configured to exert on the vibrating element 15 a second force F_{y,phase,ass}, the direction of which is the direction y of the detection mode, in phase with the vibrations along the direction x of the pilot mode. The second force F_{y, phase, ass} is then proportional to a second amplitude command, on the principle described for the first servo module 20.

The second servo module 25 comprises, in the reference example, a processor or a programmable logic circuit (such as a Field Programmable Gate Array, FPGA) configured to manage the servoing of the second amplitude command. The second servo module 25 further comprises a proximity board configured to inject the second amplitude command signal into the electrostatic device 25A.

The processor or the programmable logic circuit is in the reference example is the same as the one of the first servo module 20. Such arrangement is advantageous without being mandatory.

The processor or the programmable logic circuit is advantageously configured to manage the control of the angular frequency of the vibrations of the vibrating element 15 along the direction y of the detection mode, e.g. to the resonance angular frequency ω.

In the reference example, the proximity board is the same as the board of the first servo module 20. Such arrangement is advantageous without being mandatory.

The second servo module 25 comprises an adjustment control unit 26 apt to receive an adjustment command T^{th} and to exert from the adjustment command T^{th} an additional force F_{y,phase,supp}^{app}, the direction of which is the direction y of the detection mode, in phase with the vibrations of the vibrating element 15 along the direction x of the pilot mode.

The spectral signature of the adjustment command T^{th}, i.e. the expansion thereof into a Fourier series, is known. The coefficients T₁ to Tₙ (n being a strictly positive integer) of equation (a) hereinafter are thus known.

$${T}^{th} = {T}_{0} + {T}_{1} cos ( θ ) + {T}_{2} cos ( 2 θ ) + … + {T}_{n} cos ( n θ ) \qquad ( a )$$

To this end, the adjustment control unit 26 may comprise an electrostatic device 26A configured to actually exert an additional force F_{y,phase,supp}^{app} of the form F_{y,phase,supp}^{app}=T^{app} x in response to the adjustment command T^{th}, x being the position of the test mass M along the direction of the pilot mode.

Typically, the electrostatic device 26A is a trimming comb polarized with a very stable polarizing voltage V_{T} and apt to exert a force along the direction of the detection mode, this force being directly proportional to the position x of the test mass M along the direction of the pilot mode and proportional to the square of the polarizing voltage V_{T}. The expression “directly proportional” means herein that it is not necessary to measure or reconstruct the position x of the test mass M along the direction of the pilot mode, the force exerted by the trimming comb adjusting spontaneously to said position.

Typically, a force F exerted by means of the trimming comb is given by equation (b) hereinafter, where K denotes a gain that depends only on the geometric characteristics of the trimming comb:

$$F = {V}_{T}^{2} \cdot K \cdot x \qquad ( b )$$

Such force is obtained from the physical design of the trimming comb without the need to estimate the position x of the test mass. This force is hence indeed directly proportional to x.

It should be noted that the physical principle is entirely different from a force F_{AA} which would be obtained, as in prior art devices, by means of an excitation comb along the direction of the pilot mode, which would be given by equation c):

$${F}_{AA} = {V}_{0 x} {V}_{1 x} \cdot {K}_{AA} \cdot \hat{x} \qquad ( c )$$

where \hat{x} is an estimator of the position x of the test mass and not the actual position x of the test mass.

The trimming comb is a quadrature trimming comb, i.e. a comb involving a coupling between the pilot mode and the detection mode.

Alternatively, the trimming comb is a frequency trimming comb, i.e. a physical device configured to modify at least one of the natural angular frequencies of the test mass M along the directions x and/or y.

The servoing of the amplitude of the vibrations of the vibrating element 15 along the direction y of the detection mode is carried out by the second servo module 25 in the presence of the additional force F_{Y,phase,supp}^{app} actually applied.

The second servo module 25 is also configured to actually exert a third force F_{y,quad}^{app} on the vibrating element 15, having the direction along the direction y of the detection mode and in phase quadrature with the additional force F_{y,phase,supp}^{app}, on the basis of a spectral signature of the adjustment command T^{th} and of an estimate F_{y,phase,ass}^{est} of the second force F_{y,phase,ass}^{app} actually exerted by the second servo module 25 to servo the characteristic amplitude of the vibrations of the vibrating element 15 along the direction y of the detection mode in the presence of the additional force F_{Y,phase,supp}^{app} in two cases of movement of the sensor 10:
a first case, for which the instantaneous angular speed Ω(t) of the housing 12 with respect to the sensitive axis Z of the sensor 10 in the inertial frame of reference is imposed, to a value equal to a predetermined angular calibration velocity Ω_{cal}, and
a second case, for which the instantaneous angular speed Ω(t) is free to established under the effect of the movement of the housing 12, this movement being in particular linked to the movement of a device on which the CVG 10 is implemented, and during which the instantaneous angular speed Ω(t) is thus unknown a priori and is to be determined. In the second case, the instantaneous angular speed is thus not imposed, more particularly at the predetermined calibration angular speed Ω_{cal}, unlike in the first case.

The first and second servo modules 20, 25 are configured to exchange data with a measurement module 30 of the CVG 10, for the servoing of the vibrations of the vibrating element 15.

The measurement module 30 is apt to generate measurements of the vibrations of the vibrating element 15 along the directions x of the pilot mode and y of the detection mode and apt to exchange information with the first servo module 20 and with the second servo module 25.

In particular, the measurement module 30 is apt to measure the position x(t) (y(t), respectively) of the vibrating element 15 and/or the speed dx/dt(t) (dy/dt(t), respectively) and/or the acceleration d²x/^{dt 2}(t) (d²y/dt²(t), respectively along the direction x (along the direction y, respectively).

To this end, the measurement module 30 comprises, in the reference example, but not limited to, electrostatic means of detection 30A along the direction x of the pilot mode and electrostatic detection means 30B along the direction y of the detection mode.

Advantageously, the electrostatic means of detection 30A and 30B each form, with the test mass M, a set of interdigitated combs, on the geometrical principle shown in FIG. 6.

In the reference example, the proximity board is advantageously configured to amplify the signals detected by the measurement module 30 and to transmit the amplified signals to the processor or to the programmable logic circuit.

The measurement module 30 is also configured to exchange data with a determination module 35 of the CVG 10.

The determination module 35 is apt to exchange information not only with the measurement module 30 but also with the first and second servo modules 20, 25.

The determination module 35 is apt to determine a reference angular speed Ω_{ref} from the calibration angular speed Ω_{cal} as well as from measurements of the vibrations of the vibrating element 15 transmitted by the measurement module 30 to the first and second servo modules 20, 25 in the first case of movement of the sensor 10.

The determination module 35 is apt to determine, in the second case of movement of the sensor 10, an instantaneous measured angular speed Ωₘₑₛ(t), which is an estimator of the angular speed Ω(t) sought, on the basis of measurements of the vibrations of the vibrating element 15 transmitted by the measurement module 30 to the first and second servo modules 20, 25 and of the reference angular speed Ω_{ref}.

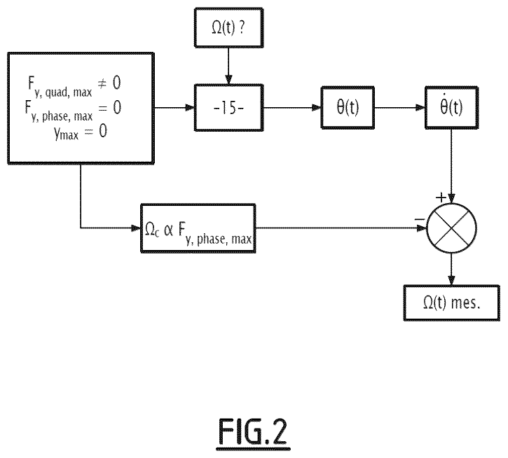

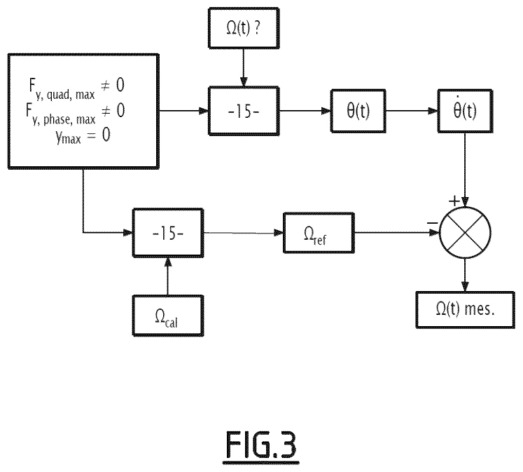

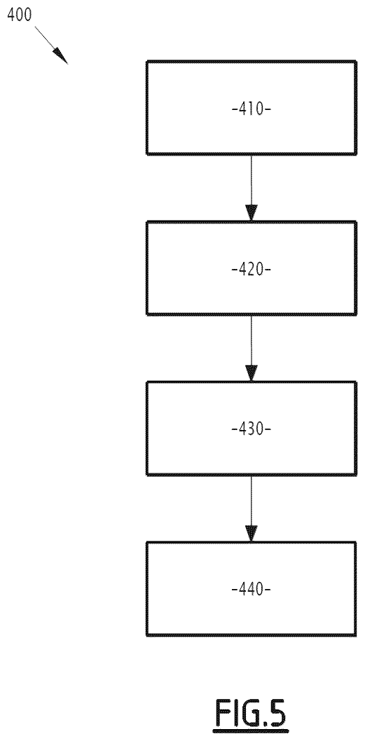

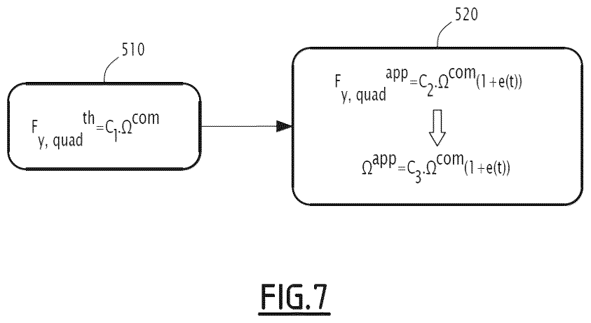

The method 400 according to the invention will now be described with reference to FIGS. 3, 5 and 8, in comparison with the prior art method shown in FIGS. 2 and 7.

The method 400 comprises an initialization step 410, a calibration step 420, an acquisition step 430 and a determination step 440 of the measured instantaneous angular speed Ωₘₑₛ(t).

The initialization step 410 comprises:
a) the supply to the first servo module 20 of the non-zero pilot amplitude xₘₐₓ to which the amplitude characteristic of the forced sinusoidal vibrations of the vibrating element 15 along the direction x of the pilot mode has to be servoed,
b) the supply to the second servo module 25 of the detection amplitude yₘₐₓ to which the characteristic amplitude of the vibrations of the vibrating element 15 along the direction y of the detection mode has to be servoed,
c) the supply to the adjustment control unit 26 of the adjustment command T^{th}, the spectral signature of which is known, and
d) the supply to the determination module 35 of the angular calibration speed Ω_{cal}.

The detection amplitude yₘₐₓ is e.g. zero.

The initialization step 410 is followed by the calibration step 420 during which:

i) the characteristic amplitude of the vibrations of the vibrating element 15 vibrating in forced sinusoidal mode along the direction x of the pilot mode is servoed to the non-zero pilot amplitude xₘₐₓ by means of the first servo module 20. For this purpose, the first servo module 20 receives measurements of the vibrations of the vibrating element 15 along the direction x of the pilot mode, from the measurement module 30.

ii) simultaneously, the additional force F_{y,phase,supp}^{app}, the direction of which is the direction y of the detection mode and in phase with the vibrations of the vibrating element 15 along the direction x, is exerted by the adjustment control unit 26 on the basis of the adjustment command T^{th}, and the characteristic amplitude of the vibrations of the vibrating element 15 along the direction y of the detection mode is servoed to the detection amplitude yₘₐₓ by means of the second servo module 25. For this purpose, the second servo module 25 receives measurements of the vibrations of the vibrating element 15 along the direction y of the detection mode and along the direction x of the pilot mode, from the measurement module 30.

iii) the second servo module 25 determines the third force F_{y,quad}^{app} to be exerted on the vibrating element 15, along the direction y of the detection mode and in phase quadrature with the additional force F_{y,phase,supp}^{app}, on the basis of an estimate F_{y,phase,ass}^{est} of the second force F_{y,phase,ass}^{app} actually exerted by the second servo module 25 to control the characteristic amplitude of the vibrations of the vibrating element 15 along the direction y in the presence of the additional force F_{y,phase,supp} app. The third force F_{y,quad}^{app} is, as will be seen later, configured to control a rotation of the directions x, y of the pilot and detection modes with respect to the housing 12.

iv) the second servo module 25 commands the exercise of the third force F_{y,quad}^{app} the operating conditions of i) and ii) being maintained: the characteristic amplitude of the vibrations of the vibrating element 15 vibrating in forced sinusoidal mode along the direction x of the pilot mode is servoed to the non-zero pilot amplitude xₘₐₓ by means of the first servo module 20, and the characteristic amplitude of the vibrations of the vibrating element 15 along the direction y is served to the detection amplitude yₘₐₓ in the presence of the additional force F_{y,phase,supp}^{app} actually applied.

v) the determination module 35 determines the reference angular speed (ref on the basis of the calibration angular speed Ω_{cal} as well as of the measurements of the vibrations of the vibrating element 15 transmitted by the measurement module 30 to the first and second servo modules 20, 25, during iv).

In the example, the additional force F_{y,phase,supp}^{app} is exerted along the direction y of the detection mode and in phase with the vibrations of the vibrating element 15 along the direction x.

More generally, the additional force is exerted by means of a device allowing to obtain a stable amplitude. In addition, the additional force is configured so as not to disturb the measurement made by the sensor.

More generally, the additional force is exerted by means of a device allowing to obtain a stable amplitude. Advantageously, said device is configured to exert an additional force the amplitude of which is constant at an accuracy of 10 ppm or less, i.e. the relative variations in amplitude of which are less than or equal to 1/100,000.

In addition, the additional force is configured so as not to disturb the measurement made by the sensor.

The calibration step 420 is followed by an acquisition step 430 reproducing steps i), ii), iii) and iv) of the calibration step, except that for the acquisition step 430, the instantaneous angular speed Ω(t) of the housing 12 with respect to the sensitive axis Z of the sensor 10 in the inertial frame of reference is not imposed. The movement of the sensor 10 thus corresponds, for the acquisition step 430, to the second case of movement described hereinabove.

At the end of the acquisition step 430, the determination step 440 is implemented by means of the determination module 35: the determination module 35 determines the measured instantaneous angular speed Ωₘₑₛ(t), which is an estimator of the instantaneous angular speed Ω(t) of the housing 12, on the basis of the measurements of the vibrations of the vibrating element 15 transmitted by the measurement module 30 to the first and second servo modules 20, 25 during the acquisition step 430 and on the basis of the reference angular speed Ω_{ref} determined at the calibration step 420.

In order to better understand the method 400 according to the invention, the theory underlying the control of an alternating rotation with a zero time-average of the coordinate frame xyZ attached to the directions x, y of the pilot and detection modes with respect to the coordinate frame XYZ attached to the housing is described hereinafter.

In order to simplify the writing of the equations making it possible to understand the method of the prior art and the method 400 according to the invention, the vibrating element 15 is modeled hereinafter by a mass M suspended on a rigid frame C by means of two pairs of springs 15A, 15B of respective stiffnesses Kₓ and K_{y}, as shown in FIG. 1.

Moreover, it is considered hereinafter that the stiffness constants and the natural angular frequencies of the vibrating element 15 are identical according to the pilot mode x and the mode y. In such particular case, it can thus be written that Kₓ=K_{y}=K and that ω₀ₓ=ω_{0y}=ω₀.

Such simplification should in no case be considered limiting for the operation of the sensor 10 according to the invention, since the following equations can be rewritten without any difficulty in the most general case.

In general, the trajectory of the mass M in forced sinusoidal regime is an ellipse in the coordinate frame XYZ.

The ellipse is reduced to a straight line segment of direction x of the pilot mode in the case where the amplitude of the vibrations according to the detection mode is servoed to a detection amplitude yₘₐₓ equal to zero.

Without making an assumption at this stage on the value of the detection amplitude yₘₐₓ, the position x of the mass M along the direction x of the pilot mode as a function of the date t is of the form x(t)=xₘₐₓ cos (ωt) and the position y of the mass M along the direction y of the detection mode as a function of the date t is of the form y(t)=yₘₐₓ sin (ωt).

If the direction x of the pilot mode with respect to the axis X of the coordinate frame XYZ attached to the housing 12 is identified by the angle θ shown in FIG. 4, the coordinates X and Y of the mass m in the coordinate frame XYZ attached to the housing 12 are related to the coordinates x and y of the mass M in the coordinate frame xyZ by equation 2:

$$[ \begin{matrix}X \\ Y\end{matrix} ] = [ \begin{matrix}cos θ & - sin θ \\ sin θ & cos θ\end{matrix} ] [ \begin{matrix}x \\ y\end{matrix} ] = R ( θ ) [ \begin{matrix}x \\ y\end{matrix} ] \qquad [ Math 2 ]$$

wherein R(θ) is the transformation matrix for changing from the coordinate frame xyZ to the coordinate frame XYZ:

$$R ( θ ) = [ \begin{matrix}cos θ & - sin θ \\ sin θ & cos θ\end{matrix} ] \qquad [ Math 3 ]$$

### I) Operating Equations Common to the Prior Art Method and to the Method 400 According to the Invention

In the prior art method shown in FIG. 2, as in the method 400 according to the invention, the transformation matrix R(θ) is a function of time. Indeed, in said methods, a rotation of the coordinate frame xyZ relative to the coordinate frame XYZ is controlled and thus a temporal evolution of the angle θ, in order to eliminate the harmonic errors of the CVG 10. Moreover, in gyroscope mode, the angle θ is free to evolve and the servos are performed in the coordinate frame xyZ.

The first time derivatives dX/dt and dY/dt of the coordinates X and Y of the mass M thus satisfy:

$$[ \begin{matrix}\dot{X} \\ \dot{Y}\end{matrix} ] = R ( θ ) [ \begin{matrix}\dot{x} - \dot{θ} y \\ \dot{θ} x + \dot{y}\end{matrix} ] \qquad [ Math 4 ]$$

The second time derivatives d²X/dt² and d²Y/dt² of the X and Y coordinates of mass M verify:

$$[ \begin{matrix}\ddot{X} \\ \ddot{Y}\end{matrix} ] = R ( θ ) [ \begin{matrix}\ddot{x} - {\dot{θ}}^{2} x - 2 \dot{θ} \dot{y} - \ddot{θ} y \\ 2 \dot{θ} \dot{x} + \ddot{θ} x + \ddot{y} - {\dot{θ}}^{2} y\end{matrix} ] \qquad [ Math 5 ]$$

In the sinusoidal regime forced to the angular frequency ω, if we neglect the terms that are not proportional to a positive integer power of the angular frequency ω in front of the other terms, equation 5 can be written in the simplified form of equation 6:

$$[ \begin{matrix}\ddot{X} \\ \ddot{Y}\end{matrix} ] = R ( θ ) [ \begin{matrix}\ddot{x} - 2 \dot{θ} \dot{y} \\ 2 \dot{θ} \dot{x} + \ddot{y}\end{matrix} ] \qquad [ Math 6 ]$$

In the frame of reference of the housing 12, the mass M is subjected to the forces F_{tot,x} and F_{tot,y} exerted by the excitation devices 20A, 25A, respectively, to the restoring forces of the springs, and to a damping that is modeled by a fluid friction force along each of the directions x and y associated with a quality factor Q.

The damping matrix A of the vibrating element 15, taking into account damping anisotropies, has the form described in equation 7:

$$A = \frac{M {ω}_{0}}{Q} . [ \begin{matrix}1 & 0 \\ 0 & 1\end{matrix} ] + [ \begin{matrix}a 1 & a 2 \\ a 2 & - a 1\end{matrix} ] \qquad [ Math 7 ]$$

The stiffness matrix K1 of the vibrating element 15, taking into account stiffness anisotropies, has the form:

$${K}_{1} = K . [ \begin{matrix}1 & 0 \\ 0 & 1\end{matrix} ] + [ \begin{matrix}r 1 & r 2 \\ r 2 & - r 1\end{matrix} ] = M {ω}_{0}^{2} [ \begin{matrix}1 & 0 \\ 0 & 1\end{matrix} ] + [ \begin{matrix}r 1 & r 2 \\ r 2 & - r 1\end{matrix} ] \qquad [ Math 8 ]$$

Moreover, when the frame of reference of the housing 12 has a rotational movement of component Ω(t) along the direction Z with respect to the inertial frame of reference, the mass M, due to the non-zero relative speed thereof in the coordinate frame the housing 12, is subjected to a Coriolis inertial force in the coordinate frame of the housing 12.

Newton's second law applied to the mass M in the non-Galilean frame of reference the housing leads to the equation 9:

$$M [ \begin{matrix}\ddot{X} \\ \ddot{Y}\end{matrix} ] {K}_{1} [ \begin{matrix}X \\ Y\end{matrix} ] + A [ \begin{matrix}\dot{X} \\ \dot{Y}\end{matrix} ] + 2 Ω [ \begin{matrix}0 & - M \\ M & 0\end{matrix} ] [ \begin{matrix}\dot{X} \\ \dot{Y}\end{matrix} ] = [ \begin{matrix}{F}_{tot , X} \\ {F}_{tot , Y}\end{matrix} ] = R ( θ ) [ \begin{matrix}{F}_{tot , x} \\ {F}_{tot , y}\end{matrix} ] \qquad [ Math 9 ]$$

To simplify the writing of the equations, the damping anisotropies are neglected hereinafter, without thereof being limiting for the implementation of the method.

Neglecting damping anisotropies, equation 9, multiplied by R(−θ) and with the approximations of equation 5, is written as follows:

$$M [ \begin{matrix}\ddot{x} - 2 \dot{θ} \dot{y} \\ 2 \dot{θ} \dot{x} + \ddot{y}\end{matrix} ] + \frac{M {ω}_{0}^{2}}{Q} [ \begin{matrix}\dot{x} \\ \dot{y}\end{matrix} ] + M {ω}_{0}^{2} [ \begin{matrix}x \\ y\end{matrix} ] + R ( - θ ) [ \begin{matrix}r 1 & r 2 \\ r 2 & - r 1\end{matrix} ] R ( θ ) [ \begin{matrix}x \\ y\end{matrix} ] + 2 Ω R ( - θ ) [ \begin{matrix}0 & - M \\ M & 0\end{matrix} ] R ( θ ) [ \begin{matrix}\dot{x} \\ \dot{y}\end{matrix} ] [ \begin{matrix}{F}_{tot , x} \\ {F}_{tot , y}\end{matrix} ] = [ \begin{matrix}{F}_{x , ass} \\ {F}_{tot , y}\end{matrix} ] \qquad [ Math 10 ]$$

In the case where the amplitude yₘₐₓ of the vibrations according to the detection mode is servoed by yₘₐₓ=0, the equation 10 takes the form:

$$M [ \begin{matrix}\ddot{x} \\ 2 \dot{θ} \dot{x}\end{matrix} ] + \frac{M {ω}_{0}^{2}}{Q} [ \begin{matrix}\dot{x} \\ 0\end{matrix} ] + M {ω}_{0}^{2} [ \begin{matrix}x \\ 0\end{matrix} ] + R ( - θ ) [ \begin{matrix}r 1 & r 2 \\ r 2 & - r 1\end{matrix} ] R ( θ ) [ \begin{matrix}x \\ 0\end{matrix} ] + 2 Ω R ( - θ ) [ \begin{matrix}0 & - M \\ M & 0\end{matrix} ] R ( θ ) [ \begin{matrix}\dot{x} \\ 0\end{matrix} ] = [ \begin{matrix}{F}_{tot , x} \\ {F}_{tot , y}\end{matrix} ] \qquad [ Math 11 ]$$

If along the x direction of the pilot mode, the terms in phase or phase opposition with the position x of the mass M from the terms in quadrature with this position are separated by decomposing F_{tot,x} into:

$${F}_{t o t , x} = {F}_{x , phase} + {F}_{x , q u a d} \qquad [ Math 12 ]$$

the system of equations 13 is obtained:

$$\{ \begin{matrix}- M {ω}^{2} x + M {ω}_{0}^{2} x + ( r 1 cos ( 2 θ ) + r 2 sin ( 2 θ ) ) x = {F}_{x , p h a s e} ( 1 ) \\ \frac{M {ω}_{0}}{Q} ω x = {F}_{x , q u a d} ( 2 )\end{matrix} \qquad [ Math 13 ]$$

The force F_{tot,x} is the first force F_{x,ass} exerted by the first servo module 20 for servoing, to the pilot amplitude, the amplitude of the vibrations according to the pilot mode.

Similarly, if one separates, along the direction y of the detection mode, the terms in phase or in phase opposition with the position x of the mass M from the terms in quadrature with said position, by decomposing F_{tot,y} into:

$${F}_{tot , y} = {F}_{y , phase} + {F}_{y , q u a d} \qquad [ Math 14 ]$$

the system of equations 15 is obtained:

$$\{ \begin{matrix}( r 2 cos ( 2 θ ) - r 1 sin ( 2 θ ) ) x = {F}_{y , phase} ( 1 ) \\ ( - 2 \dot{θ} - 2 Ω ) M ω x = {F}_{y , q u a d} ( 2 )\end{matrix} \qquad [ Math 15 ]$$

The term F_{y,phase}, of amplitude F_{y,phase,max}, is managed by the second servo module 25 which receives the instruction to servo the amplitude of the vibrations according to the detection mode to Yₘₐₓ=0 and the term F_{y,quad}, of amplitude F_{y,quad,max}, is the third force imposed by the second servo module 25.

Equation 15(2) shows that in order to command the rotation of the coordinate frame xyZ relative to the coordinate frame XYZ, it is necessary to command the third force F_{y,quad} of non-zero amplitude F_{y,quad,max}, with the direction y of the detection mode and in phase quadrature with the vibrations of the mass M along the direction x of the pilot mode.

The directions x and y of the pilot and detection modes then rotate at an angular speed de/dt different from the instantaneous angular speed Ω(t) and one can both:
reduce or eliminate harmonic errors by controlling a rotation of the directions by periodically changing the direction of the third force F_{y,quad}, and
deduce the instantaneous angular speed Ω(t) from the measurement of de/dt according to equation 16:

$$Ω = - \dot{θ} - \frac{{F}_{y , quad , max}}{2 M ω {x}_{max}} \qquad [ Math 16 ]$$

### II) Prior Art Method

In the methods of the prior art, in order to obtain the third force F_{y,quad}, the characteristics of the electric voltage V_{exc,y}(t) to be applied to the electrostatic excitation device 25B are supplied to the second servo module 25, during a step which could be considered as an initialization step. Thereby, in particular, the amplitudes and pulses of the different components of the voltage V_{exc,y}(t) which should be in phase quadrature with the position x of the mass M, are provided.

On the principle of equation 1, the electric voltage V_{exc,y}(t) is typically of the form V_{exc,y} (t)=V_{0y}+V_{1y} sin (ωt), so that the force F_{y,quad}^{th} theoretically applied to the mass M is proportional to the DC component V_{0y} of the electric voltage V_{exc,y}(t) and to a geometric factor g_{geom} characteristic of the electrostatic excitation device 25B. In the case of the methods of the prior art, one theoretically commands:

$${F}_{y , quad}^{t h} ( t ) = {g}_{g e o m} ( 2 {V}_{0 y} {V}_{1 y} sin ( {ω}_{0} t ) ) \qquad [ Math 17 ]$$

This command step is represented by step 510 in FIG. 7, wherein it is observed that the force F_{y, quad}^{th} is commanded with the aim of causing a rotation of the direction of the pilot mode in the frame of reference of the housing at a command angular speed Ω_{com}.

The scale factor between the commanded force F_{y,quad}^{th} and the command angular speed Ω_{com} is constant and denoted by C1.

Due to delays and gain errors of the electronic components and of the mechanical components, including detection errors on the position of the vibrating element, errors on voltages V_{0y}. V_{1y}, as well as errors on the sinusoidal signal sin (ω₀t), the force F_{y,quad}^{app} actually applied to the test mass M differs at greater or lesser extent from the commanded force F_{y,quad}^{th}, both in amplitude and in phase.

We can model the difference between the amplitude F_{y,quad,max}^{th} of the commanded force and the amplitude F_{y,quad,max}^{app} of the force actually applied by:

$${F}_{y , quad , max}^{app} = ( 1 + e ( t ) ) {F}_{y , quad , max}^{th} = {C}_{2} {Ω}^{com} ( 1 + e ( t ) ) \qquad [ Math 18 ]$$

where e(t) is a very unstable error term due to the many parameters of the electronic components and of the mechanical components that cause same and C2 denotes a constant scale factor.

Following the control step 510, the force F_{y,quad}^{app} is actually exerted during an acquisition step 520, which results in an effective rotation of the direction of the pilot mode in the frame of reference of the housing at an effective angular speed Ω^{app} different from the command angular speed Ω_{com}. The two angular speeds are linked by the following equation, where C3 denotes a constant scale factor:

$${Ω}^{app} = {C}_{3} {Ω}^{com} ( 1 + e ( t ) )$$

In the measurement method of the prior art, the instantaneous angular speed measured is deduced from equation 16 and from the amplitude F_{y,quad,max}^{th} controlled for the third force F_{y,quad}, which is supplied during the initialization step to the second servo device 25, according to the formula:

$${Ω}^{mes} ( t ) = - {\dot{θ}}^{mes} ( t ) - \frac{{F}_{y , quad , max}^{th}}{2 M ω {x}_{max}} \qquad [ Math 19 ]$$

The effective instantaneous angular speed Ω^{app}, which would be deduced from equation 16 and from the amplitude F_{y,quad,max}^{app} actually obtained for the third force F_{y,quad} if same were perfectly known (i.e. if all the error sources were perfectly controlled and known), has the expression:

$${Ω}^{app} ( t ) = - {\dot{θ}}^{mes} ( t ) - \frac{{F}_{y , quad , max}^{app}}{2 M ω {x}_{max}} \qquad [ Math 20 ]$$

The error made in the method of the prior art on angular speed therefore has the expression:

$${Ω}^{mes} - {Ω}^{app} = \frac{- {F}_{y , quad , max}^{th} + {F}_{y , quad , max}^{app}}{2 M ω {x}_{max}} = e ( t ) \frac{{F}_{y , quad , max}^{th}}{2 M ω {x}_{max}} \qquad [ Math 21 ]$$

Hence, this error is a scale factor error. It should be understood that if the term e is not strictly constant in time, the error related to the scale factor does not have a zero-time average even if the time average of the commanded force F_{y, quad}^{th} is zero. Moreover, the error within a reversal period is all the greater as e(t) is large. Finally, even if the term e(t) was obtained by means of a calibration upstream of the measurement, because of the variety of causes of the error, it is not possible to consider that the calibration will remain correct over the shorter or longer term.

### III) Method 400 According to the Invention

The method according to the invention aims to solve such technical problem, by exerting a third force F_{y,quad}^{app} of better controlled amplitude than in the methods of the prior art and by using another way of estimating the angular speed to be measured.

For the reason thereof, the amplitude of the third force is not provided in the form of a setpoint value that would be provided during the initialization step.

In the case of the method 400 according to the invention, during the acquisition step 430, the adjustment command T^{th} is implemented by the adjustment control unit 26 of the second servo module 25, so that the additional force F_{y, phase, supp}^{app}, of intensity T^{app}|x|, in phase with the position x of the mass M and having the direction y of the detection mode, is effectively imposed on the mass M. The servoing of the amplitude of the vibrations of the mass M along the direction y of the detection mode is carried out by the second servo module 25 in the presence of the additional force F_{Y,phase,supp}^{app} actually applied.

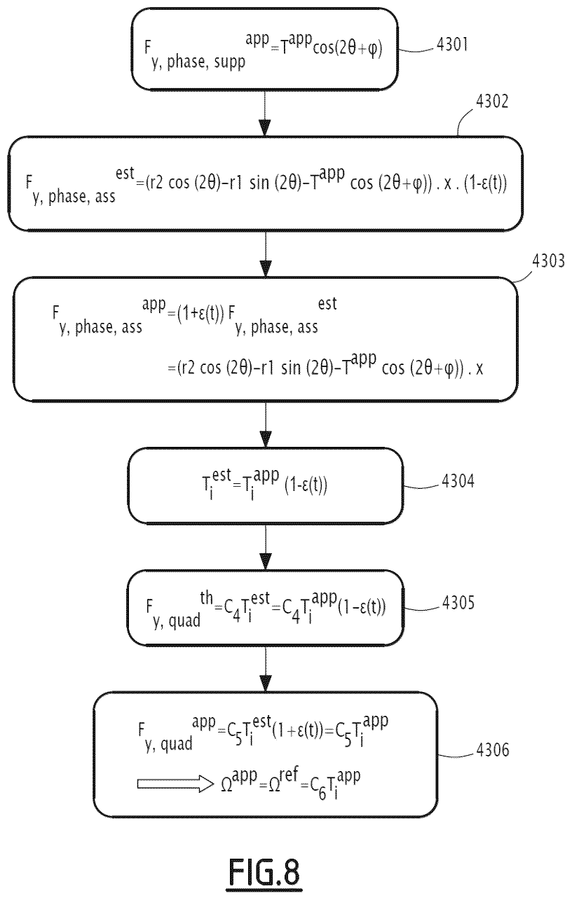

The acquisition step 430 is shown in detail in FIG. 8.

The additional force F_{y,phase,supp}^{app} is actually exerted in an application sub-step 4301.

Because of the presence of the additional force, the system of equations 15 can thus be written for the method of the invention in the form of the system of equations 22:

$$[ Math 22 ]$$

$$\{ \begin{matrix}( r 2 cos ( 2 θ ) - r 1 sin ( 2 θ ) ) x = & ( 1 ) \\ {F}_{y , phase , ass} + {F}_{y , phase , supp}^{app} = & \\ {F}_{y , phase , ass} + {T}^{app} cos ( 2 θ + φ ) x & \\ ( - 2 \dot{θ} - 2 Ω ) M ω x = {F}_{y , quad}^{app} & ( 2 )\end{matrix}$$

with φ a constant value. For example, φ=0 if quadrature comb trimming combs are used, and φ=π/2 if frequency comb trimming combs are used.

The force F_{y,phase,ass}^{app} which is effectively exerted by the second servo device 25 in phase with the position x of the mass M to implement the servoing of the vibrating element 15 along the direction y of the detection mode thus has the expression:

$${F}_{y , phase , ass}^{app} = ( r 2 cos ( 2 θ ) - r 1 sin ( 2 θ ) - {T}^{app} cos ( 2 θ + φ ) ) x \qquad [ Math 23 ]$$

It can be seen that part of the force F_{y,phase,ass}^{app} intervenes to counter the additional force F_{y,phase,supp}^{app} applied by means of the injection of the adjustment command T^{th}

During an estimation sub-step 4302 of the acquisition step 430, the servo device 25 estimates the force F_{y,phase,ass}^{est} to be controlled in order to actually exert the force F_{y,phase,ass}^{app} on the vibrating element 15 for the servoing thereof in the presence of the additional force F_{y,phase,supp}^{app} actually exerted by the adjustment control unit 26.

The force F_{y,phase,ass}^{app} is actually exerted during a first exercise sub-step 4303, in the presence of the additional force F_{y,phase,supp}^{app}.

The difference between the force F_{y,phase,ass}^{app} actually applied to exercise substep 4303 and the estimator F_{y,phase,ass}^{est} of the force to be controlled to exert said force, obtained in estimation sub-step 4302, can be modeled by equation 24:

$${F}_{y , phase , ass , max}^{app} = ( 1 - ε ( t ) ) {F}_{y , phase , ass , max}^{est} \qquad [ Math 24 ]$$

The term ε(t) being much less than 1, one can still write, as was done in FIG. 8:

$${F}_{y , phase , ass , max}^{est} = ( 1 - ε ( t ) ) {F}_{y , phase , ass , max}^{app} \qquad [ Math 25 ]$$

or else:

$${F}_{y , phase , ass}^{est} = ( r 2 cos ( 2 θ ) - r 1 sin ( 2 θ ) - {T}^{app} cos ( 2 θ + φ ) ) ( 1 - ε ( t ) ) x \qquad [ Math 26 ]$$

It should be noted that the term T^{app} cos (2θ+φ) x is present in the force F_{y,phase,ass}^{app} and in the estimator F_{y,phase,ass}^{est} of the method 400 (unlike the methods of the prior art) because of the injection of the adjustment command T^{th}.

During an extraction sub-step 4304, the second servo device 25 extracts from the force F_{y,phase,ass}^{est} thus estimated at least one estimator T_{I}^{est} of an amplitude T_{I}^{app} of the harmonic decomposition of T^{app}, based on the spectral signature of the adjustment command T^{th}.

By way of non-limiting example, T^{th} may be chosen to have the form:

$${T}^{t h} = {T}_{2} cos ( 2 θ + φ ) \qquad [ Math 27 ]$$

wherein the angle θ denotes the angular position of the direction x of the pilot mode with respect to the reference axis X of the coordinate frame XYZ attached to the housing 12.

In such case, the mean value of the term T^{app} cos(2θ+φ) over a period characteristic of the variations of the angle θ is equal to T₂^{app}/2, in such a way that it is possible to extract T₂^{app} from the estimated force F_{y,phase,ass}^{est} by the servo device 25 and to evaluate T₂^{app}, e.g. by filtering with an averaging filter.

It is also possible to use an odd-order harmonic. Such arrangement facilitates the separation of the component of interest from the physical signals. As an example, the terms Tᵢ of the spectral signature of the adjustment command T^{th} may be constant, or else sinusoidal of the form Tᵢ=λᵢ cos (αᵢ t+βᵢ) where αᵢ, λᵢ and βᵢ are predetermined constants.

Then, during a control sub-step 4305, the processor of the servo device 25 commands the third force F_{y, quad}^{th} having the direction y of the detection mode but in phase quadrature with the additional force F_{y,phase,supp}^{th}.

As can be seen in FIG. 8, the third controlled force F_{y,quad}^{th} comprises a term proportional to each of the estimators Tᵢ^{est}, the scale factor being constant and denoted by C₄.

During a second sub-step of exercise 4306, the control of the third force F_{y,quad}^{th} results in the exercise of the third force F_{y,quad}^{app} actually applied.

Since the errors are the same in each of the sub-steps, the third force F_{y,quad}^{app} actually applied is in phase quadrature with the additional force F_{y,phase,supp}^{app} and thus ultimately effectively comprises a component proportional to each of the real harmonics Tᵢ^{app} of T^{app} used, the proportionality factor being constant and denoted by C₅.

Equation 16 can then be rewritten as follows, wherein C₆ is a constant scale factor:

$${Ω}_{mes} = - \dot{θ} - \frac{{T}_{i}^{app}}{2 M ω} = - \dot{θ} - {C}_{6} {T}_{i}^{app} \qquad [ Math 28 ]$$

The third force F_{y,quad}^{app} actually exerted thus has the effect of imposing an additional angular rotation speed on the coordinate frame of the wave, the additional angular speed being proportional to the amplitude Tᵢ^{app} used.

It is important to understand that the error made between the second estimated force F_{y,phase,ass}^{est} and the second effectively exerted force F_{y,phase,ass}^{app} is the same as the error between the third commanded force F_{y,quad}^{th} and the third force effectively exerted F_{y,quad}^{app} the conversion chain being the same in both cases.

Consequently, if in the preliminary calibration step 420, the predetermined calibration angular speed Ω_{cal} has been imposed on the unit 12 with respect to the axis Z, with the same adjustment command T^{th}, it is also known, the conversion chain remaining the same, that:

$${Ω}_{cal} = - {\dot{θ}}_{cal} - \frac{{T}_{i}^{app}}{2 M ω} = - {\dot{θ}}_{cal} - {C}_{6} {T}_{i}^{app} = - {\dot{θ}}_{cal} + {Ω}_{ref} \qquad [ Math 29 ]$$

The additional angular speed Ω^{app} actually applied in the case of the method according to the invention is thus exactly the reference angular speed Ω_{ref} determined during the calibration step 420 and is not tainted by errors occurring in the method according to the prior art, as can be seen in FIG. 8.

Thereby, all that remains is to determine the instantaneous angular speed Ω(t) sought using the reference angular speed Ω_{ref} determined during the calibration step 420, according to equation 30:

$${Ω}_{mes} = - \dot{θ} + {Ω}_{cal} + {\dot{θ}}_{cal} = - \dot{θ} + {Ω}_{ref} \qquad [ Math 30 ]$$

Said equation does not at any time require an explicit calculation of the amplitude of the third applied force, due to the calibration step 420. The scale factor involved in the methods of the prior art is thus totally eradicated from the method 400.

The only errors that taint the measurement are the errors related to the implementation of the adjustment command T^{th}, which should be as stable as possible between the calibration step 420 and the acquisition step 430.

More particularly, the electrostatic device 26A makes it possible, by the configuration thereof, to dispense with the measurement of the position of the mass M along the direction of the pilot mode and thus to generate an additional force F_{y, phase, supp}^{app} which is particularly stable.

To control such errors as well as possible, an electrostatic excitation device 26A is advantageously chosen, the geometry variations of which are as small as possible.

For the same purpose, a polarizing voltage source V_{T} which is as stable as possible, is advantageously chosen.

Preferably, the polarizing voltage source V_{T} comprises filtering means configured to eliminate the variable components of the voltage at the terminals thereof.

Advantageously, the instantaneous angular speed Ω_{cal} of the housing 12 with respect to the axis Z is zero during the calibration step 420. Such arrangement makes it possible to minimize the error on the angular speed Ωₘₑₛ determined in the determination step 440, in particular on the basis of equation 24.

Advantageously, a first adjustment command T^{th} is provided during a first time interval t1 and a second adjustment command which is the opposite of the first adjustment command T^{th} is provided during a second time interval t2, such that the direction (x) of the pilot mode relative to the housing rotates in a first direction during the first time interval t1 and in a direction opposite to the first direction during the second time interval t2.

Due to such arrangement, it is possible, by suitably choosing the first time interval t1 and the second time interval t2, to cancel the errors in the scale factor and to minimize the harmonic defects that taint the measurements.

Equivalently, during the control substep 4305, a first sign can be applied during a first time interval t1, so that the third commanded force F_{y, quad}^{th} has a first direction during the first time interval t1. The opposite sign can then be applied during a second time interval t2 so that the third commanded force F_{y,quad}^{th} has a direction opposite to the first direction during the second time interval t2.

In summary, the method 100 according to the invention has the following specificities.

Firstly, the rotation of the direction of the pilot mode is obtained by applying an angular speed whose amplitude is proportional to the amplitude of the additional force F_{y,phase,supp}^{app} which is very stable, unlike the methods of the prior art.

The additional force F_{y,phase,supp}^{app} can be obtained, in particular, by means of trimming combs, the stability of the additional force thus depending on the stability of the voltages used and the air-gaps of the trimming combs. The stability of the additional force F_{y,phase,supp}^{app} is thus much better controlled than the stability of a force obtained by means of a conventional precession command, which undergoes all the variations of the corresponding electronic components.

Secondly, the angular speed suppressed at the output to compensate for the precession control, i.e. the third force F_{y,quad}^{app}, is directly proportional to the amplitude of the additional stable force F_{y,phase,supp}^{app} injected at the input, and is not the angular speed associated with an electronically injected precession control, intrinsically unstable.

Thirdly, by playing on the signs of the adjustment command, it is possible to choose the direction of the third force F_{y, quad}^{app} and thereby to cause a rotation of the direction of the pilot mode in a first direction for a first period of time and in a second direction for a second period of time.

If the first duration and the second duration are properly chosen, the scaling factor errors can be eliminated precisely. Thereof is not the case in the methods of the prior art because of the instability of the scale factor.

It should be noted that the stable force injected at the input does not reduce the performance of the gyroscopic measurement device.

1. A gyroscopic measurement method by means of a sensor comprising a housing and a vibrating element apt to vibrate relative to the housing in a vibration plane simultaneously along a direction of a pilot mode and along a direction of a detection mode different from the direction of the pilot mode, the method comprising the following steps:
initialization, during which a pilot amplitude, a detection amplitude, an adjustment command with a predetermined spectral signature, and a calibration angular speed are provided;
calibration, comprising:
i) servoing to the pilot amplitude a first amplitude of forced sinusoidal vibrations of the vibrating element along the direction of the pilot mode,
ii) simultaneously, exerting a first stable force on the vibrating element configured so as not to disturb the measurement of the sensor from the adjustment command, and servoing to the detection amplitude a second amplitude of vibrations of the vibrating element along the direction of the detection mode,
iii) simultaneously, exerting a second force on the vibrating element along the direction of the detection mode and in phase quadrature with the first force, the second force being determined on the basis of a third force which estimates the force actually exerted to servo the second amplitude, and of the spectral signature of the adjustment command and being configured to cause a rotation of the direction of the pilot mode relative to the housing,
an instantaneous angular speed of the housing with respect to a sensitive axis being imposed and equal to the calibration angular speed during i), ii) and iii);
iv) determining a reference angular speed from the calibration angular speed and from measurements of the vibrations of the vibrating element during iii);
an acquisition step, which comprises i), ii) iii) of the calibration with a free instantaneous angular speed;
determination of a measured instantaneous angular speed of the housing with respect to the sensitive axis from measurements of the vibrations of the vibrating element during the acquisition step, and of the reference angular speed.

2. A gyroscopic measurement method by means of a sensor comprising a The method of gyroscopic measurement according to claim 1, wherein for the calibration, the first force is exerted on the vibrating element, along the direction of the detection mode and in phase with the vibrations of the vibrating element along the direction of the pilot mode.

3. The method according to claim 1, wherein the calibration angular speed is zero.

4. The method according to claim 1, wherein the detection amplitude is zero.

5. The method according to claim 1, wherein determining the second force during the calibration and during the acquisition comprises filtering the third force which estimates the force actually exerted to servo the second amplitude.

6. The method according to claim 1, wherein the first force is exerted by means of an electrostatic device configured to exert a force directly proportional to a position of the vibrating element along the direction of the pilot mode and according to the adjustment command.

7. The method according to claim 1, wherein adjustment command is of the form:
$${T}^{th} = {T}_{0} + {T}_{1} cos ( θ ) + {T}_{2} cos ( 2 θ ) + ... + {T}_{n} cos ( n θ )$$
where n is a strictly positive integer, Tᵢ—for i being an integer between 1 and n—is a constant term and θ is an angular position of the direction of the pilot mode with respect to a reference axis of a coordinate frame attached to the housing, the reference axis being orthogonal to the sensitive axis.

8. The method according to claim 1, wherein a first adjustment command is provided during a first time interval and a second adjustment command which is opposite to the first adjustment command is provided during a second time interval, such that the direction of the pilot mode relative to the housing rotates in a first direction during the first time interval and in a direction opposite to the first direction during the second time interval.

9. A gyroscopic sensor comprising:
a housing;
a vibrating element apt to vibrate relative to the housing in a vibration plane simultaneously along a direction of a pilot mode and along a direction of a detection mode different from the direction of the pilot mode;
a first servo module configured to receive a pilot amplitude and to servo a first amplitude of forced sinusoidal vibrations of the vibrating element along the direction of the pilot mode to a predetermined pilot amplitude;
a second servo module configured to:
a) exert on the vibrating element a first stable force configured so as not to disturb the measurement of the sensor from an adjustment command a spectral signature of which is predetermined,
b) servo, to a predetermined detection amplitude, a second amplitude of vibration of the vibrating element along the direction of the detection mode, and
c) exert a second force on the vibrating element, along the direction of the detection mode and in phase quadrature with the first force, the second force being configured to cause a rotation of the direction of the pilot mode relative to the housing, the second force being determined on the basis of a third force which is an estimate of the force actually exerted to servo the second amplitude and of the spectral signature of the adjustment command;
a measurement module configured to generate measurements of the vibrations of the vibrating element along the direction of the pilot mode and the direction of the detection mode and to exchange data with the first servo module and with the second servo module;
a determination module configured to exchange data with the measurement module and with the first and second servo modules and to determine:
i) a reference angular speed on the basis of a predetermined calibration angular speed and on the basis of measurements of the vibrations of the vibrating element transmitted by the measuring module in a calibration mode for which an instantaneous angular speed of the housing with respect to a sensitive axis is imposed and equal to the calibration angular speed, and
ii) a measured instantaneous angular speed of the housing with respect to the sensitive axis from measurements of the vibrations of the vibrating element in an acquisition mode wherein the instantaneous angular speed is free and from the reference angular speed.

10. The gyroscopic sensor according to claim 9, wherein the first servo module and the second servo module comprise electrostatic means of excitation.

11. A computer program comprising instructions that cause a gyroscopic sensor comprising:
a housing;
a vibrating element apt to vibrate relative to the housing in a vibration plane simultaneously along a direction of a pilot mode and along a direction of a detection mode different from the direction of the pilot mode;
a first servo module configured to receive a pilot amplitude and to servo a first amplitude of forced sinusoidal vibrations of the vibrating element along the direction of the pilot mode to a predetermined pilot amplitude;
a second servo module configured to:
a) exert on the vibrating element a first stable force configured so as not to disturb the measurement of the sensor from an adjustment command a spectral signature of which is predetermined,
b) servo, to a predetermined detection amplitude, a second amplitude of vibration of the vibrating element along the direction of the detection mode, and
c) exert a second force on the vibrating element, along the direction of the detection mode and in phase quadrature with the first force, the second force being configured to cause a rotation of the direction of the pilot mode relative to the housing, the second force being determined on the basis of a third force which is an estimate of the force actually exerted to servo the second amplitude and of the spectral signature of the adjustment command;
a measurement module configured to generate measurements of the vibrations of the vibrating element along the direction of the pilot mode and the direction of the detection mode and to exchange data with the first servo module and with the second servo module;
a determination module configured to exchange data with the measurement module and with the first and second servo modules and to determine:
i) a reference angular speed on the basis of a predetermined calibration angular speed and on the basis of measurements of the vibrations of the vibrating element transmitted by the measuring module in a calibration mode for which an instantaneous angular speed of the housing with respect to a sensitive axis is imposed and equal to the calibration angular speed, and
ii) a measured instantaneous angular speed of the housing with respect to the sensitive axis from measurements of the vibrations of the vibrating element in an acquisition mode wherein the instantaneous angular speed is free and from the reference angular speed to perform the method according to claim 1.
